(19) United States
(12) Patent Application Publication
(10) Pub. No.: US 2024/0292170 A1
(43) Pub. Date: Aug. 29, 2024

(54) SOUND PROCESSING APPARATUS, DECODER, ENCODER, BITSTREAM AND CORRESPONDING METHODS

(71) Applicant: Fraunhofer-Gesellschaft zur Förderung der angewandten Forschung e.V., München (DE)

(72) Inventors: Jürgen HERRE, Erlangen (DE); Andreas SILZLE, Erlangen (DE); Nils PETERS, Erlangen (DE); Matthias GEIER, Erlangen (DE); Christian BORSS, Erlangen (DE); Dennis ROSENBERGER, Erlangen (DE)

(21) Appl. No.: 18/657,959

(22) Filed: May 8, 2024

Related U.S. Application Data
(63) Continuation of application No. PCT/EP2022/081065, filed on Nov. 8, 2022.

(30) Foreign Application Priority Data
Nov. 9, 2021 (EP) 21207255.7

(51) Int. Cl. H04S 5/00; G10L 19/26

(52) U.S. Cl. CPC H04S 5/005; G10L 19/26; H04S 2420/01

(57) ABSTRACT

A sound processing apparatus comprises a panner for spatial positioning of a plurality of input signals and for combining them into at least two spatial signals. The sound processing apparatus comprises a dispersion filter stage for receiving the spatial signals and for dispersion filtering the spatial signals to obtain a set of filtered spatial signals. The sound processing apparatus comprises an interface for providing a number of output signals, based on the filtered spatial signals.

### CROSS-REFERENCE TO RELATED APPLICATIONS

This application is a continuation of copending International Application No. PCT/EP2022/081065, filed Nov. 8, 2022, which is incorporated herein by reference in its entirety, and additionally claims priority from European Application No. EP 21207255.7, filed Nov. 9, 2021, which is also incorporated herein by reference in its entirety.

The present invention relates to a sound processing apparatus for providing output signals based on filtered spatial signals and to a decoder for decoding a bitstream that comprises such an apparatus. The present invention further relates to an encoder for encoding an audio signal into a bitstream, relates to a bitstream and relates to a methods for sound processing and to a method for encoding an audio scene. The present invention in particular relates to a dispersion filter for early reflections.

### BACKGROUND OF THE INVENTION

When rendering sound into virtual acoustic environments, like in Virtual Reality (VR) or Augmented Reality (AR), accurate and/or plausible rendering of acoustics is important. Usually, the acoustic behavior of the virtual environment is described by the behavior of direct sound, early reflections and late reverb.

Early reflections are often computed in virtual acoustic real-time environments via the image source method [1]. The computation of these specular reflections is known to be efficient, but their acoustic perception can lack realism. This lack of realism may be caused by the algorithmic assumptions that all reflective surfaces are smooth and cause only specular reflections without acoustic scattering, or that the sound propagation in the air is a linear process without any turbulences or different propagation speeds dependent on a temperature difference in the room for example.

In reality, acoustic reflections and sound propagation in the air do not behave fully linearly. By applying a purposefully designed filter, the effect of acoustic dispersion can efficiently improve the perception of early reflection simulations and enhanced plausibility and realism with a very moderate cost in computational complexity.

Known methods with simulating early reflections are:
Image source method [1]
particle simulation method [2]
Ray Tracing [3]
Beam Tracing [4]

These geometric acoustic methods use different approaches to calculate early or all reflections in a room simulation. Already Gerzon [5] formulated, “One of the imperfections in modelling rooms by geometric models is that dispersion effects at room boundaries are generally not well modeled, and this generally results in an unpleasant coloration”. He proposed second order allpass filters to improve this. This introduces a complexity of one “allpass” filter per reflection.

Moore mentions in [6] that exponentially decaying white noise is perceptually very similar to the impulse response of concert halls.

FIG. 11 shows an overall architecture that applies allpass filtering to early reflections. Specifically, an allpass filter or dispersion filter, DF, 1002 is employed for each early reflection, ER, 1004, where each allpass filter 1002 models the (temporal) dispersion effect that happens to this early reflection 1004 on its way from the source via air and reflective surfaces to the listener. Reflections on material on different dispersive strength can be modelled by applying allpass filters 1002 with different amount of dispersion. In this way, an individual modelling of the dispersion effect for each early reflection 1004 is achieved and the complexity of the allpass filtering operations grows linearly with the number of early reflections considered. This can introduce considerable computational complexity in the system.

The known use of dispersion filtering for binaural reproduction shown in FIG. 11 illustrating a number of n dispersion filters that are needed for a small number of n early reflections further comprises a direct sound processor 1006 and a late reverb/reverberation processor 1008. Binauralization filters 1012 are adapted to provide inputs for combiners 1014₁ 1014₂ to provide signals for loudspeakers 1016.

There is, thus, a need for efficiently providing early reflection filtering.

### SUMMARY

According to an embodiment, a sound processing apparatus may have: a panner for spatial positioning of a plurality of input signals and combining the input signals into at least two spatial signals; a dispersion filter stage for receiving the spatial signals and for dispersion filtering the spatial signals to obtain a set of filtered spatial signals; an interface for providing a number of output signals, based on the filtered spatial signals.

According to another embodiment, a decoder for decoding a bitstream including information representing an audio signal may have an inventive sound processing apparatus.

Another embodiment may have an encoder for encoding an audio signal into a bitstream, the encoder configured for generating the bitstream so as to include one or more of: information, e.g., a boolean flag, that allows to enable or disable a dispersion filter processing; information, e.g., a boolean flag, that enables or disables the dispersion filter processing for early reflections sounds; information, e.g., a boolean flag, that enables or disable the dispersion filter processing for diffracted sounds; information indicating a parameter to signal the duration of the dispersion filter used for the dispersion filter processing e.g. in ms, as example between 0 ms and 100 ms, information indicating a parameter to signal the dispersion filter gain, information indicating a parameter to signal the spatial spread of the dispersion filter, e.g., between 0 degree and ±180 degrees According to another embodiment, a bitstream may have: information indicating at least one spatial positioned input signal of an audio scene; and one or more data fields including information that includes an indication of a use and/or configuration of a dispersion filter for generating audio signals from the bitstream.

A finding of the present invention is that, based on the assumption of a similar dispersive properties for each early reflection to be similar, e.g., because they hit the same wall material, the order of the (identical) allpass filters, the binauralization stages and the summation/combination can be interchanged since all are linear systems. Embodiments relate to the finding that by providing spatial signals, e.g., from the early reflections, and to provide those spatial signals to dispersion filter stages, the number of dispersion filters can be related to the number of spatial signals instead of the number of input signals, e.g., at early reflections. Thereby, a comparatively low number of dispersion filters may be used which allows to efficiently provide for early reflection filtering.

According to an embodiment, a sound processing apparatus comprises a panner for spatial positioning of a plurality of input signals and for combining them into at least two spatial signals. The sound processing apparatus comprises a dispersion filter stage for receiving the spatial signals and for dispersion filtering the spatial signals to obtain a set of filtered spatial signals. The sound processing apparatus comprises an interface for providing a number of input signals based on the filtered spatial signals.

According to an embodiment, a decoder for decoding a bitstream comprising information representing an audio signal comprises a sound processing apparatus according to an embodiment. This allows to efficiently provide for the audio signal from the bitstream.

According to an embodiment, an encoder for encoding an audio signal into a bitstream is configured for generating the bitstream so as to comprise one or more of information that allows to enable or disable a dispersion filter processing, information that enables or disables the dispersion filter processing for early reflections sounds, information that enables or disables the dispersion filter processing or a diffracted sounds, information indicating a parameter to signal the duration of the dispersion filter's impulse response used for the dispersion filter processing, information indicating a parameter to signal the dispersion filter gain; and information indicating a parameter to signal the spatial spread of the dispersion filter. This allows to efficiently provide the bitstream to be precisely decoded.

According to an embodiment, a bitstream comprises information indicating at least one spatial position input signal of an audio scene and one or more data fields comprising information that comprises an indication of a use and/or configuration of a dispersion filter for generating audio signals from the bitstream.

According to an embodiment, a method for sound processing comprises spatial positioning of a plurality of input signals and combining them into at least two spatial signals, dispersion filtering the spatial signals to obtain a set of filtered spatial signals, and providing a number of output signals, based on the filtered spatial signals.

According to an embodiment, a method for encoding an audio scene comprises generating, from the audio scene, information indicating at least one spatially positioned input signal of the audio scene. The method comprises providing one or more data fields comprising information that comprises an indication of a use and/or configuration of the dispersion filter for generating audio signals from the encoded audio scene, e.g., to be inserted into a bitstream.

Further embodiments relate to a computer program for representing such a method.

### BRIEF DESCRIPTION OF THE DRAWINGS

Embodiments of the present invention will be detailed subsequently referring to the appended drawings, in which:

FIG. 1 shows a schematic block diagram of a sound processing apparatus according to an embodiment;

FIG. 2 shows a schematic block diagram of a sound processing apparatus according to an embodiment, the sound processing apparatus comprising a direct sound processor and a late reverb processor;

FIG. 3 shows a schematic representation of a signal flow according to an embodiment;

FIG. 4 shows a head-related coherence measurement in an echoic chamber inside a human ear channel for illustrating a head related transfer function using in some embodiments;

FIG. 5 shows a schematic block diagram of a sound processing apparatus according to an embodiment, the sound processing apparatus comprising a panner having a virtual loudspeaker processor;

FIG. 6 shows a schematic block diagram of a sound processing apparatus according to an embodiment that may be connected to a number of loudspeakers;

FIG. 7 shows a schematic block diagram of an encoder according to an embodiment;

FIG. 8 shows a schematic block diagram of a decoder according to an embodiment;

FIG. 9 shows a schematic flowchart of a method for sound processing according to an embodiment;

FIG. 10 shows a schematic flowchart of a method according to an embodiment that may be used for encoding an audio scene; and

FIG. 11 shows an overall architecture that applies allpass filtering to early reflections.

### DETAILED DESCRIPTION OF THE INVENTION

Equal or equivalent elements or elements with equal or equivalent functionality are denoted in the following description by equal or equivalent reference numerals even if occurring in different figures.

In the following description, a plurality of details is set forth to provide a more thorough explanation of embodiments of the present invention. However, it will be apparent to those skilled in the art that embodiments of the present invention may be practiced without these specific details. In other instances, well known structures and devices are shown in block diagram form rather than in detail in order to avoid obscuring embodiments of the present invention. In addition, features of the different embodiments described hereinafter may be combined with each other, unless specifically noted otherwise.

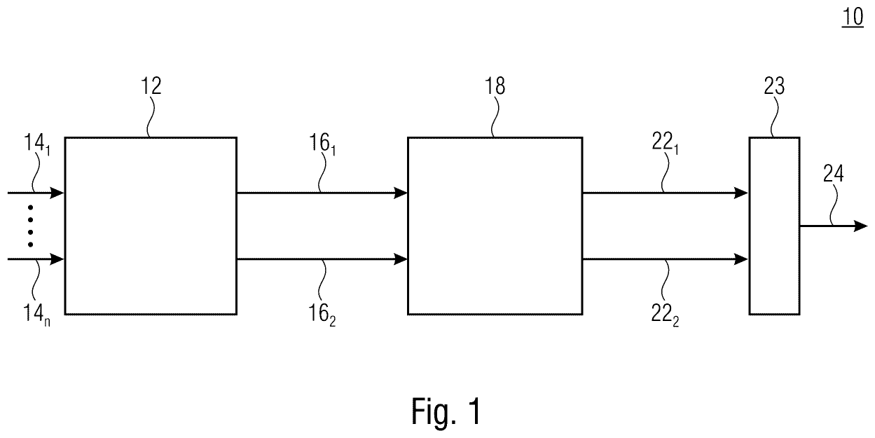

FIG. 1 shows a schematic block diagram of a sound processing apparatus 10 according to an embodiment. The sound processing apparatus 10 comprises a panner 12 for spatial positioning of a plurality of input signals 14₁ to 14ₙ with n>1. The input signals may comprise, for example, early reflections and/or diffracted sound sources of an audio scene. According to embodiments, the number of early reflections, ER, may be a constant or varying number of at least two, ERs, at least six ERs, e.g., of first order, such as for a shoebox shaped room but may also be any other number as high as 100 ER or more for higher order ERs of a complex shaped room. The early reflections can be individual per each direct sound source or they can be a general pattern independent of the number of direct sounds.

The panner 12 is configured for combining the input signals into at least two spatial signals 16₁ and 16₂. For example, the spatial signals 16₁ and 16₂ may relate to left/right-signals intended for a stereo-system such as a headphone. A higher number of spatial signals may represent a higher order spatial scene.

The sound processing apparatus comprises a dispersion filter stage 18 for receiving the spatial signals 16₁ and 16₂ or signals derived therefrom, and for dispersion filtering the spatial signals 16₁ and 16₂ to obtain a set of filtered spatial signals 22₁ and 22₂. A number of filtered spatial signals 22 is possibly but necessarily equal to a number of spatial signals 16.

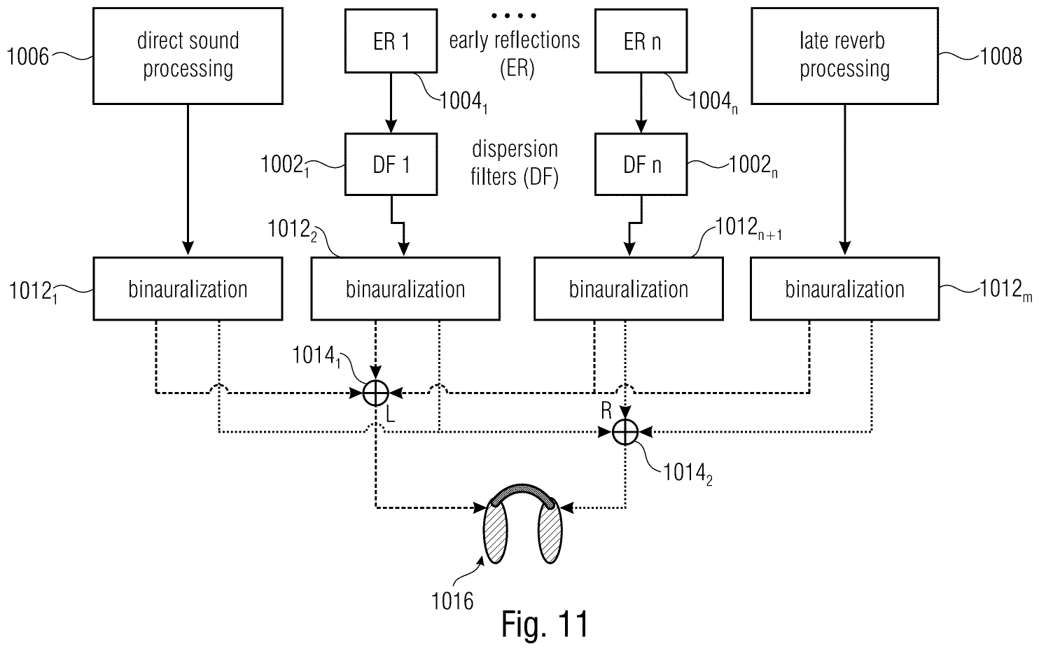

According to an embodiment, the dispersion filter stage 18 comprises, for providing the dispersion filtering, at least one dispersion filter such as filter 1002 shown in FIG. 11. The dispersion filter may comprise or may be implemented as an allpass filter. Alternatively or in addition, the dispersion filter stage 18 may comprise at least one dispersion filter being a Finite Impulse Response, FIR, filter and/or an Infinite Impulse Response IIR, filter. Each of those configurations may be suitably adapted to operate in a sound processing apparatus according to an embodiment.

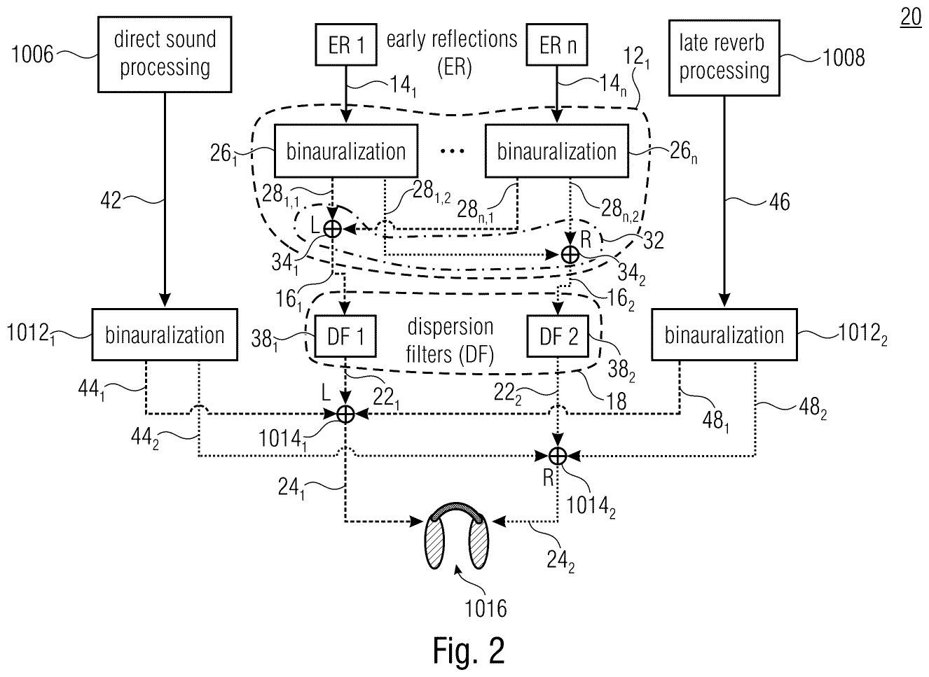

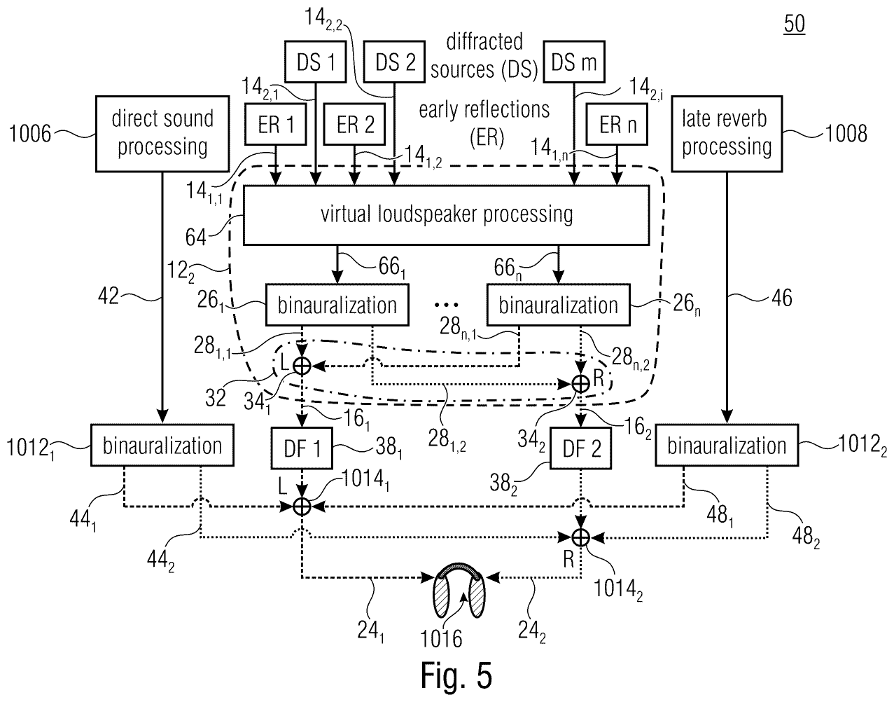

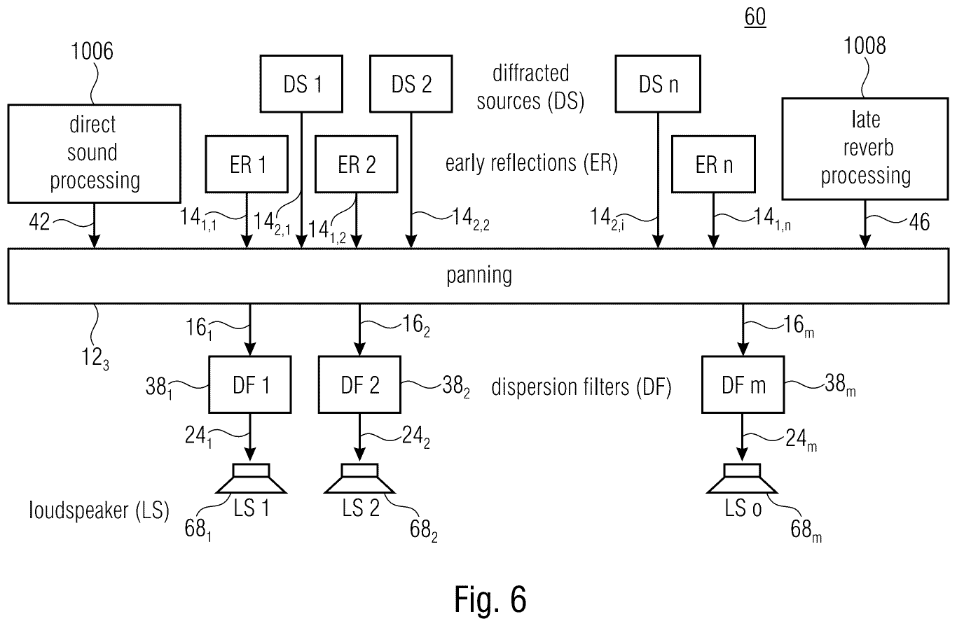

The input signals 14 may be received, for example, from a bitstream and/or may be provided, e.g., by a renderer forming a part of the sound processing apparatus 10 or a different sound processing apparatus described herein, the renderer configured for providing the plurality of input signals. For example, the sound processing apparatus 10 may be configured for providing a direct sound component and a reverberated sound component. As illustrated in FIG. 2 and/or FIG. 5, such a direct sound component 42 and/or reverberated sound component 46 may be excluded from the dispersion filter stage 18. However, as shown, for example, in FIG. 6, the components may also be fed to a panner and may be fed, at least indirectly, to dispersion filters.

According to an embodiment, at least one dispersion filter of the dispersion filter stage 18 may comprise a time-variant filter characteristic, for example, a low-frequency temporal modulation of a noise sequence can be used to achieve a more complex and natural/lively sound dispersion characteristic.

The sound processing apparatus comprises an interface, e.g., a wired, wireless, electrical, optical or other type of interface 24 configured for providing a number of at least one output signal 24, the at least one output signal 24 being based on the filtered spatial signals 22₁, 22₂. For example, the output signal 24 may contain or may be associated with an audio channel, e.g., a left channel or a right channel of a stereo system or a different channel, in connection with a different sound reproduction system.

According to an embodiment, the input signals 14₁ to 14ₙ may comprise at least one early reflection signal and/or at least one different sound signal of an audio scene.

FIG. 2 shows a schematic block diagram of a sound processing apparatus according to an embodiment. The sound processing apparatus 20 may comprise a direct sound processor 1006 connected to a binauralization filter 1012₁ as discussed in connection with FIG. 11. The direct sound processor may be configured for processing a direct sound component. The sound processing apparatus 20 may further comprise a late reverb processor 1008 connected to binauralization filter 1012₂ as discussed in connection with FIG. 11. The late reverb processor may be configured for processing a late reverb component of the audio scene.

In accordance with embodiments, a panner 12₁ that may be used in sound processing apparatus 10, may comprise binauralization stages 26₁ and 26₂. Each of the binauralization stages 26₁ and 26₂ may be configured for receiving one of the input signals 14₁ to 14ₙ of a number of n input signals that are, for example, early reflections (ER). The binauralization stages 26₁ and 26₂ may be adapted similar to the binauralization filters of FIG. 11, however, they are connected to input signals according to the embodiment whilst FIG. 11 shows a configuration in which the binauralization filters receive their input from dispersion filters.

The binauralization stages 26₁ and 26₂ may be configured for binauralizing the received input signal 14₁ to 14ₙ for obtaining a respective first binauralized channel 28_{1,1}, 28_{n,1} respectively and a second binauralized channel 28_{1,2}, 28_{n,2}, respectively. Note that the binauralization is an example of providing audio signals for a stereo system. In case a high number of channels or loudspeakers is used, the binauralization may be extended without any limitations so as to provide for a higher number of channels 28.

The panner 12₁ may comprise a combiner 32 having one or more combining stages such as combining stages 34₁ and 34₂, each configured for providing a combination of respective first binauralized channels 28_{1,1} and 28_{n,1} on the one hand, e.g., by using a combiner stage 34₁ and for providing a combination of respective second binauralized channels 28_{1,2} and 28_{n,2} on the other hand, e.g., by using the combiner stage 34₂. This may form at least a basis of the spatial signals 16₁ and 16₂. Thereby each spatial signal 16₁ and 16₂ may be based on a respective combination of corresponding or associated binauralized channels provided by the binauralization stages 26₁ and 26ₙ.

The dispersion filter stage 18 may comprise dispersion filters 38₁ and 38₂ configured for providing filtered output signals 22₁ and 22₂.

Whilst using a number of n binauralization stages 26 for the number of n input signals, a use of a lower number of dispersion filters 38 is possible by implementing the present invention, e.g., a number of dispersion filter stages that corresponds to the number of output signals, filter output signals 24₁, 24₂ respectively. In the illustrated embodiment of FIG. 2, the sound processing apparatus 20 may be configured for filtering all n input signals of exactly two dispersion filters 38₁ and 38₂ of the dispersion filter stage 18. According to an embodiment, the number of exactly two dispersion filters 38₁ and 38₂ may be independent from a number of input signals 14₁ to 14ₙ and/or independent from a number of sound sources providing the plurality of input signals 14₁ to 14ₙ.

Combiners 1014₁ and 1014₂ may be used to combine the filtered spatial signals 22₁ and 22₂ with a respective channel of the binauralization filters 1012₁ and 1012₂ in case the direct sound processor 1006 and/or the late reverb processor 1008 forms a part of the sound processing apparatus 20.

The direct sounds processor 1006 may provide for a direct sound signal 42 forming an input for the binauralization filter 1012₁ that provides for direct sound channels 44₁ and 44₂. Being in accordance with the loudspeaker setup 1016, e.g., a stereo system having a left, L, and a right, R, channel. The late reverb processor 1008 may provide for a late reverb signal 46 that maybe fed to the binauralization filter 1012₂ to derive therefrom late reverb channels 48₁ and 48₂ being also in accordance with the loudspeaker setup 1016.

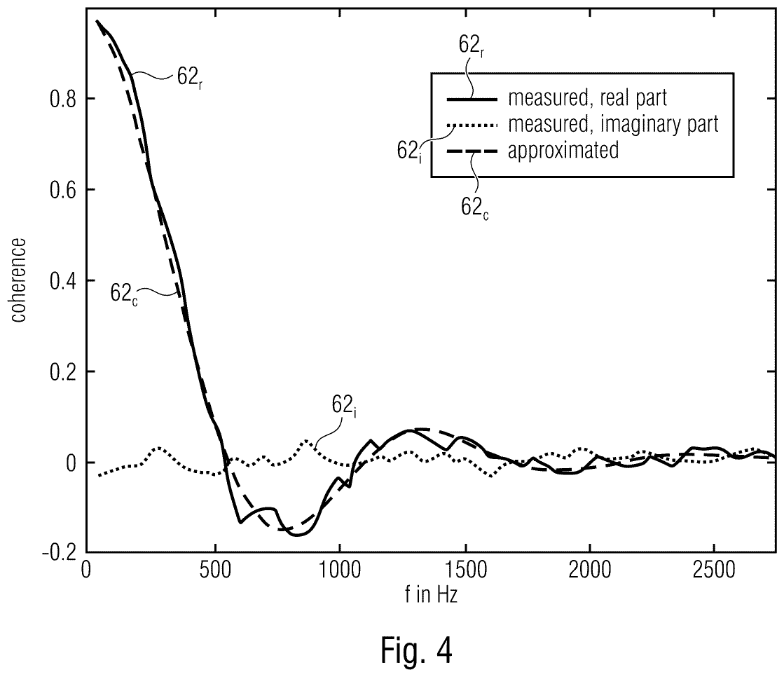

One aspect of the embodiments described herein is to use known dispersion filters, that are applied to the sum ear signals rather than the individual reflections. Embodiments also relate to the way stereo effects are handled. The design of the filter with the given correlation, see FIG. 4, at this position in the signal processing chain with this intended purpose differs from known structures.

In other words, FIG. 2 shows the inventive use of dispersion filtering for early reflection processing in binaural reproduction for which only two filters are needed. With regard to a filter application, one of the embodiments and a possibility to apply the dispersion filtering to the early reflection signals. Specifically, each early reflection 14 is first binauralized, e.g., using appropriate head-related transfer functions, HRTFs, reflecting their direction of incidents, and then the left and right ear binaural are fed through a single pair of dispersion filters. This may reduce the computational complexity added by dispersion filtering by a factor of n/2 where n is the number of early reflections, i.e., the saving grows with the number of early reflections considered.

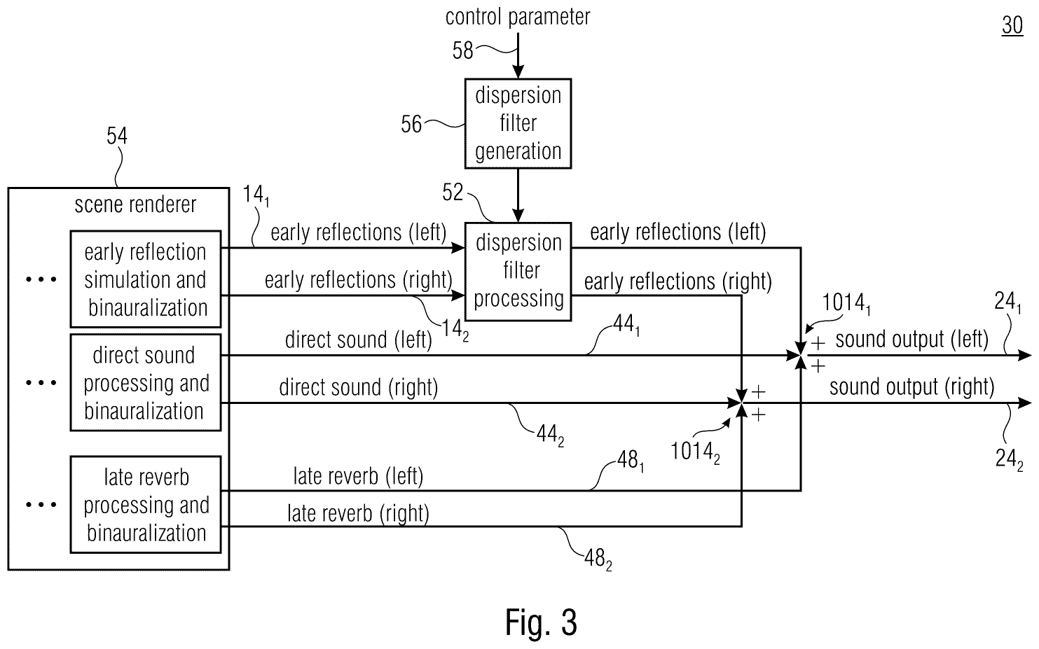

FIG. 3 shows a schematic representation of a signal flow 30 and, in addition, visualizes the generation of the dispersion filters which may possibly form an important or even essential part of embodiments described herein as it is designed to fulfill a number of perceptual criterion. Dispersion filter generation may be useful, according to embodiments, at a beginning or setup of an audio processing apparatus but may also be useful during operation, e.g., as un update of the filters.

A renderer 54 may provide for the generation of channels 14₁, 14₂; 44₁, 44₂; 48₁ and 48₂. The renderer 54 may form a part of a sound processing apparatus described herein, a part of an encoder to provide for an encoded bitstream according to an embodiment and/or a part of a decoder to decode an encoded bitstream in accordance with an embodiment.

A dispersion filter generation unit 56, i.e., an entity to determine properties and/or settings and/or parameters of one or more of the dispersion filters 38 of the dispersion filter stage 18 may be adapted to control the dispersion filter processing 52, e.g., based on one or more control parameters 58. The dispersion filter generator 56 may be a part of an encoder, a decoder and/or of a sound processing apparatus described herein, e.g., the sound processing apparatus 10 and/or 20. That is, a sound processing apparatus described herein may comprise a dispersion filter generator 56 configured for generating and/or updating at least one dispersion filter of the dispersion filter stage.

In FIG. 3, a dispersion filtering for early reflection signals for binaural reproduction including dispersion filter generation is shown using a dispersion filter processing 52. As illustrated in FIG. 3, it may be sufficient to only apply the dispersion filter processing 52 to the binauralized early reflections ER components, e.g., forming input signals 14₁ and 14₂. This may be implemented, e.g., by use of the dispersion filter stage 18 in the sound processing apparatus 10 and/or 20.

It may be sufficient to only apply the dispersion filter processing 52 to the binauralized ER components which may be interpreted, according to some embodiments, to not apply the dispersion filter processing 52 to the direct sound channels 44₁, 44₂ and the late reverb channels 48₁ and 48₂. In this way, transient sounds in the direct path are not smeared and may remain “clean” with regard to a perception of a listener. Furthermore, only a number of two filtering operations (based on the binauralization) are needed independently from the number of sound sources or early reflections. In case a higher number of spatial signals is generated for a loudspeaker setup, the number of two dispersion filters may correspondingly increase but still remain comparatively low when compared to providing a DF for each of the n input signals.

However, whilst some of the embodiments described herein are described in connection with handling early reflection sound components by means of the inventive dispersion filters, all benefits described in connection therewith can also be applied to diffracted sound, DS, components. Thus, embodiments and illustrative figures relating to early reflections, e.g., FIG. 2, that denote the early reflection processing shall also be understood to be applicable, in addition or as an alternative, to the handling of diffracted sound.

In an embodiment, the design of the acoustic dispersion filter for early reflections is a FIR filter structure based on two windowed white noise sequences, one for the L-channel and one for the R-channel, which can be generated, for example, once during the initialization phase of the renderer. This does not preclude to re-generate the filters or to update the filters later. These L and R noise sequences may have an at least on average flat frequency response/spectrum and may provide for a temporal smearing, i.e., dispersion, for the early reflection signal. They may be designed based on one or more of the input parameters or control parameter 58:
length determining an amount of temporal spread provided by the dispersion filter;
a spatial spread, e.g., by a high-level control to change a degree of Inter-channel Cross Correlation; and/or
a gain value.

For example, the L and R channel noise sequences may be either
identical windowed white noise sequences for L and R channel (temporal smearing), or
two white noise sequences that have a well-defined/controlled (high) correlation according to perceptual criteria (spatial-temporal smearing).

With regard to the dispersion filter generator, according to an embodiment, same may be configured for generating the dispersion filter as a first dispersion filter for a first spatial signal, e.g., a left signal or right signal. The sound processing apparatus may comprise a memory having stored thereon a set of stored noise signals of a same energy, at least within a tolerance range and with different degrees of correlation with respect to each other. The sound processing apparatus may be configured for selecting, from the stored noise signals, as a basis for the noise sequences. That is, according to embodiments, a dispersion filter of the dispersion filter stage is based on a windowed noise sequence. For example, the windowed noise sequence is based on or corresponds to a white noise sequence. Different dispersion filters of the dispersion filter stage may, thus, be based on an identical windowed noise sequence or on different noise sequences that have a predefined correlation according to perceptual criteria.

According to an embodiment, the sound processing apparatus may be configured for obtaining the noise signals based on at least one of:
a characteristic that the noise signals are identical or weakly decorrelated sequences;
a parameter such as a parameter received as a bitstream parameter in a bitstream, indicating a length of the sequences;
a parameter, e.g., a parameter received as a bitstream parameter in a bitstream, indicating a decorrelation or a spatial spread strength; and
a parameter, e.g., received as a bitstream parameter in a bitstream, related to Interaural Cross Correlation, IACC of a sound source with a small frontal aperture. For example, the dispersion filter generator may be configured for generating at least two dispersion filters with a frequency-dependent filter decorrelation, e.g., obtained based on IACC. At least within a tolerance range, the different noise sequences comprise an equal energy level.

The parameter length from the input parameters may define the FIR filter length, e.g., in a range of at least 10 ms and at most 20 ms. Alternatively, also the slope of the window function can be used to control the dispersion filter length.

Note that also non-white noise sequences may be used in order to apply a desired additional frequency response to the earlier reflections. This may be obtained without relevant extra computational costs.

The spatial dispersion effect may be achieved by a carefully defined small degree of decorrelation between the two filters. Completely uncorrelated filters might result in completely uncorrelated ear signals. This is a possibly undesired effect because it is an unnatural effect: even for fully diffuse sound fields, the Interaural correlation of real binaural signals, e.g., binaural signals recorded from a dummy head, have a high correlation at low frequencies due to the wavelength being larger than the head diameter, see, for example, FIG. 4, and a full decorrelation would prohibit sound localization and might introduce perceptual artifacts.

FIG. 4 shows a head-related coherence measurement in an echoic chamber inside a human ear channel illustrating a curve 62ᵣ for showing a measured real part and a curve 62ᵢ to represent the measured imaginary part and their approximated coherence 62_{c}, refer to [7]. An abscissa shows a frequency in Hertz and the ordinate represents the coherence.

According to an embodiment, the dispersion filter stage may comprise at least a pair of dispersion filters for filtering a pair of spatial signals 16₁ and 16₂, wherein the different dispersion filters comprise a frequency-dependent filter decorrelation that may be obtained, for example, based on an Interaural Cross Correlation, IACC. The degree of the frequency-dependent filter decorrelation may be modeled, e.g., by the dispersion filter generator 56, using the IACC and can, in an embodiment of the invention, be set via a spatial spread parameter, e.g., forming at least a part of the full parameter 58. That is, the dispersion filter generator may be configured for generating the first dispersion filter and the second dispersion filter with a frequency-dependent filter correlation, e.g., obtained based on IACC. The frequency-dependent cross-correlation between the e.g., two (L and R) noise sequences can be set based on the frequency-dependent IACC target values that are created by two or more frontal sound sources that are distributed within a specific aperture angle with respect to the listener, e.g., a (de) correlation that is invoked at the listener's ear by two sources at ±4° azimuth. A spatial spread of 0 value may create two equal noise sequences that may be considered as fully correlated sequences. Increasing the spatial spread value gradually decreases the cross-correlation between the two noise sequences. Other approaches for generating the weakly decorrelated white noise sequences can be applied without changing the overall concept. For example, the coherence of the sum of the binauralized early reflections may be used to adjust a coherence of the dispersion filters such that the desired coherence is achieved.

The two (in the example of having two spatial channels) white noise sequences may have an equal energy at least within a tolerance range and may be weighted by a window function with an adjustable decay time. The window function may show a decaying property, e.g., an exponentially decaying. The decay time may form at least one of the control parameters provided to the dispersion effect processing, i.e., control parameter 58 in FIG. 3.

Applying the decaying window function to the noise sequence may create a compact, but densely populated FIR filter coefficient set which temporarily blurs the signal to the discrete early reflection image sources.

The two weighted noise sequences may be normalized to be energy-preserving. In this way, an amount of temporal dispersion can be controlled without undesired influence on the signal aptitude. Alternatively or in addition, an additional overall filter gain can be set using a gain parameter, being provided as control parameter 58. According to an embodiment, the sound processing apparatus may be energy-preserving and/or may be adjustable in view of a filter gain.

It is a benefit of embodiments described therein, e.g., of an inventive method, that little computation in an effort, e.g., by only having two filtering operations, is needed for processing all early reflections of a virtual acoustic scene and that no additional runtime computation is needed to achieve spatial-temporal dispersion, if desired. For example, a sound processing apparatus described herein may be configured for applying dispersed filter processing with the dispersion filter stage only to the binauralized input signals.

Embodiments described herein are not limited to the above. From the above, embodiments that are in accordance with the present invention may deviate or extend in view of at least one of:

### Using Alternative Filter Designs

Although having made reference to an FIR-based implementation, the inventive concept can also be implemented using different filter types, e.g., for implementing the dispersion filters. For example, the FIR filters can be converted into low-complexity IIR filter designs.

### Using Time-Varying Filters

Alternatively or in addition, time-variant versions of filters, e.g., by low-frequency temporal modulation of the two noise sequences, can be used to achieve more complex and natural/lively sound dispersion characteristics.

### Extension to Virtual Loudspeaker Reproduction

In binaural audio reproduction it is quite common to reproduce sound sources (including early reflections) by panning them between “virtual loudspeakers” which are then binauralized using corresponding head-related transfer functions, HRTFs. In case of a binauralization after the usage of virtual loudspeakers, there are still only two dispersion filters needed in an embodiment of the present invention which will be described in connection with FIG. 5. That is, the binauralization stages of a sound processing apparatus described therein may be configured according to a head-related transfer function, HRTF.

### Extension to Processing of Diffracted Sound

In virtual sound rendering, especially in 6 Degrees of Freedom (6DoF) rendering where the listener can move freely within the virtual scene, the rendering of diffracted sound components is important. Diffracted sound appears when sound propagates around one or several corners before it reaches the listener. Due to the bending of the sound around diffraction corners, the sound is usually attenuated in its high-frequency content and—due to the indirect and possibly long propagation path—also more reverberant than the direct sound components. Also this effect can be modeled with good quality and high efficiency by applying the inventive dispersion filters to the summed contributions of the diffracted sound components in a similar or even very much in the same way it is applied to the early reflections. This is also shown in FIG. 5 and may be implemented in addition or as an alternative to the virtual loudspeaker reproduction.

FIG. 5 shows a schematic block diagram of a sound processing apparatus according to an embodiment. The sound processing apparatus 50 comprises a panner 12₂ that may be used, for example, in the sound processing apparatus 10 and/or 20. The panner 12₂ comprises a virtual loudspeaker processor 64 configured for receiving and processing the input signals to obtain intermediate spatial signals 66₁ to 66ₙ that may operate as described in connection with FIG. 2, i.e., they may be configured according to a head-related transfer function, HRTF.

Each binauralization stage 26₁ to 26ₙ may receive one of the intermediate spatial signals 66₁ to 66ₙ and may binauralize the received intermediate spatial signal 66 for obtaining a respective binauralized channel 28_{1,1} to 28_{n,2}. The combiner 12₂ may comprise the combiner 32 having the combiner stages 34₁ and 34₂, the combiner 32 is configured for providing the first combination of the first binauralized channels of the binauralization stages, e.g., L, wherein the spatial signal 16₁ is based on the combination of combiner stage 34₁ and spatial signal 16₂ being based on a combination provided by combiner stage 34₂. Although not limited hereto, also sound processing apparatus 50 may be configured for providing exactly two audio channels or output signals 24₁ and 24₂.

The virtual loudspeaker processor 64 may be configured for receiving input signals that may comprise early reflections ER, diffracted sources DS or combinations thereof. For example, a number of n of one or more earlier reflections 14_{1,1} to 14_{1,n} may be fed to the virtual loudspeaker processor. Alternatively or in addition, a number of at least one diffracted source 14_{2,1} to 14_{2,i} may be fed to the virtual loudspeaker processor 64. The numbers of n and j may be independent or unrelated from each other and may each comprise a value being variable over time or constant that is at last two.

Although illustrating the diffracted sources 14_{2,i} i=1, . . . , j, j≥1 as being an input for the virtual loudspeaker processor 64, when referring to the sound processing apparatus 20, such an input signal may also be directly fed to the binauralization stages 26. As indicated in FIG. 5 by displaying one single headphone describing a use of one listener, exactly two binauralizers 26₁ and 26ₙ with n=2 may be sufficient or are needed, e.g., one for the left and right headphone signal.

According to the concept implemented in the sound processing apparatus 50 a use of dispersion filtering together with virtual loudspeaker processing for binaural reproduction is enabled. For such a concept, only two dispersion filters are needed, sufficient respectively. According to an embodiment that is possibly but not necessarily less advantageous, one dispersion filter may be applied to the early reflection sound component ER contained in each virtual loudspeaker signal.

### Extension to Conventional Loudspeaker Reproduction

In order to implement the inventive concept for conventional loudspeaker reproduction rather than binaural headphone-based reproduction, one dispersion filter may be applied to each loudspeaker signal. That is, based on a higher number of audio channels a corresponding number of larger than two dispersion filters may be used.

FIG. 6 shows a schematic block diagram of a sound processing apparatus 60 according to an embodiment that may be connected to a number of loudspeakers 68₁ to 68_{M}. The number m of dispersion filters 38 may be equal to the number o of loudspeakers 68. However, the number j of diffracted sources and the number n of ER is not necessarily equal and normally clearly higher than the number of loudspeakers.

While according to the sound processing apparatus 20 and/or 50 the sound processing apparatus may be configured for excluding a direct sound component 42 and/or a reverberated sound component 46 from the dispersion filter stage 18, the panner 12₃ of the sound processing apparatus 60 may be configured for receiving said sound components or sound channels 42 and/or 46. The spatial signals 16₁ to 16ₘ may, thus, also comprise information being based from the direct sound processor 1006 and/or from the late reverb processor 1008.

The sound processing apparatus 16 may comprise, as may the sound processing apparatus 10, 20 and/or 50, the direct sound processor 1006 and/or the late reverb processor 1008.

According to the embodiment implemented in the sound processing apparatus 60, the panner 12₃ may be configured for receiving the input signals 14_{1,1} to 14_{2,n} comprising at least one early reflection signal and/or at least one diffracted sound signal. The panner 12₃ may be configured for receiving a direct sound component 42 and a reverberated sound component 46 associated with the input signals 14. The spatial signals 16 may each be associated with a loudspeaker of a loudspeaker setup comprising loudspeakers 68₁ to 68ₘ.

The panner 12, 12₁, 12₂ and/or 12₃ may comprise a direct sound binauralization stage for receiving and binauralizing the direct sound component 42 to obtain respective components each related to one of the audio channels. The sound processing apparatus may comprise a combiner for combining signals related to the same audio channel to obtain a first audio signal and a second audio signal, e.g., as an output signal. For example, the combiner stages 1014₁ and 1014₂ may be used for such a combination.

Alternatively or in addition, the late reverberation processor 1008 being part of the sound processing apparatus may form a basis to implement a panner to comprise a reverberation binauralization stage for receiving and binauralizing the late reverberation component 46 to obtain respective components each related to one of the audio channels. The sound processing apparatus may comprise a combiner, e.g., combiner stages 1014₁ and/or 1014₂ for combining signals related to a same audio channel to obtain a first audio signal and a second audio signal, e.g., as an output signal.

In other words, FIG. 6 shows use of an embodiment related to dispersion filtering with real loudspeaker reproduction.

Based on the finding that the order of the allpass filters, the binauralization stages and the summation can be interchanged since all are linear systems, the embodiments propose a filter design that blurs/smears discrete early reflection generated by the image source model, both in time and—optionally—space and involves only little computation. The spatial and/or temporal components can be parametrized individually.

A bitstream may be used to provide information about a respective audio scene. Such a bitstream may be generated by an encoder and may be used, processed and/or decoded by a decoder. Alternatively or in addition, a sound processing apparatus described herein may be configured for receiving the input signals or a basis thereof as part of a bitstream and for using and/or configuring the dispersion filter stage 18 based on one or more data fields of the bitstream, the one or more data fields comprising an indication of use and/or configuration of the dispersion filter.

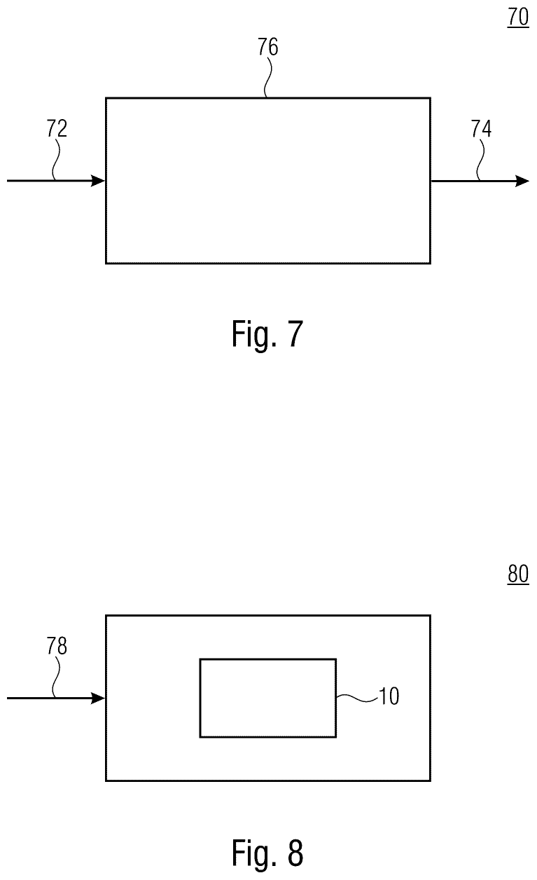

FIG. 7 shows a schematic block diagram of an encoder 70 according to an embodiment that is configured for encoding an audio signal 72 into a bitstream 74. The encoder 70 is configured for generating the bitstream 74, e.g., using a bitstream generator 76, so as to comprise one or more of:
information, e.g., a boolean flag, that allows to enable or disable a dispersion filter processing;
information, e.g., a boolean flag, that enables or disables the dispersion filter processing for early reflections sounds;
information, e.g., a boolean flag, that enables or disable the dispersion filter processing for diffracted sounds
information indicating a parameter to signal the duration of the dispersion filter used for the dispersion filter processing e.g. in ms, as example between 0 ms and 100 ms
information indicating a parameter to signal the dispersion filter gain
information indicating a parameter to signal the spatial spread of the dispersion filter, e.g., between 0 degree and ±180 degrees

Another embodiment is, thus, the bitstream comprising information indicating at least one spatial position input signal of an audio scene and one or more data fields comprising information that comprises an indication of a use and/or configuration of a dispersion filter for generating audio signals from the bitstream. Such information is not necessary in known systems but may configure the advantageous use of dispersion filters according to the described embodiments. For example, such a bitstream may be the bitstream 70. In such an embodiment, the information in the one or more data fields may indicate the above, e.g., at least one of:
information, e.g., a boolean flag, that allows to enable or disable a dispersion filter processing;
information, e.g., a boolean flag, that enables or disables the dispersion filter processing for early reflections sounds;
information, e.g., a boolean flag, that enables or disable the dispersion filter processing for diffracted sounds
information indicating a parameter to signal the duration of the dispersion filter used for the dispersion filter processing e.g. in ms, as example between 0 ms and 100 ms or between 0 ms and 1000 ms
information indicating a parameter to signal the dispersion filter gain
information indicating a parameter to signal the spatial spread of the dispersion filter, e.g., between 0 degree and ±180 degrees

FIG. 8 shows a schematic block diagram of a decoder 80 according to an embodiment that is configured for a decoding a bitstream 78. The decoder 80 may comprise a sound processing apparatus described herein, e.g., sound processing apparatus 10, 20, 50 and/or 60. The bitstream 78 may be in accordance with the bitstream 74 and/or may comprise an indication of a use and/or configuration of a dispersion filter for generating audio signals from the bitstream 78.

With regard to a bitstream syntax, in an application scenario that involves an encoder that encodes the audio components of virtual auditory scenes into a bitstream and the bitstream is possibly stored and/or transmitted to a decoder/renderer for the auditory scene, whilst considering at least some of the information identified above to be signaled via a single bit or flag, the bitstream data may include one or more of the following in an embodiment of the invention:
EnableDispersionFilter Flag (On/Off)
   A boolean flag that allows to enable or disable the dispersion filter processing
EnableDispersionFilterForER Flag (On/Off)
   A boolean flag that enables or disable the dispersion filter processing for early reflections sounds
EnableDispersionFilterForDiffraction Flag (On/Off)
   A boolean flag that enables or disable the dispersion filter processing for diffracted sounds
DispersionFilterLength Int [0,1000]
   A parameter to signal the duration of the dispersion filter e.g. in ms, typically between 0 and 100 ms or 1000 ms
DispersionFilterGain
   A parameter to signal the dispersion filter gain
DispersionFilterOpeningAngle
   A parameter to signal the spatial spread of the dispersion filter, e.g., between 0 and ±180 degrees

Further aspects of the present invention, of at least some of the embodiments respectively relate to signal processing aspects and to bitstream aspects.

### Signal Processing Aspects

A two-channel filter that creates a (binaural) dispersion effect
   Embodiment: FIR filter
   The filters process the L and R channel signals of the binauralized and summed early reflections contribution of the virtual acoustic scene (rather than individual reflections)
Alternatively, when using virtual or real loudspeaker reproduction, one filter is used for the early reflection contributions in each (virtual or real) loudspeaker signal
The dispersion effect modifies a signal in the time and—optionally—in the spatial domain
The temporal and spatial strength can be controlled via control parameters
The filter is energy preserving but its overall gain can be modified
A filter that is generated based on a stored set of (white) noise signals with equal energy and various degrees of correlation
   They are identical or weakly decorrelated sequences
   length of sequences can be controlled, e.g. by a bitstream parameter
   decorrelation can be controlled, e.g. by a bitstream parameter
   based on IACC of a sound source with a small frontal aperture. The aperture can, e.g. be controlled by a bitstream parameter
A dispersion filter generator that generates filter sequences with above properties
All of the above filters, applied to diffracted sound components

### Bitstream Aspects

In addition to the details given above relating, at least in parts, to flags to be part of the bitstream, the bitstream may also comprise a more general and/or more precise information, e.g., using a higher number of bits. That is, embodiments related to a bitstream having an indication indicating a use and/or configuration of the dispersion filter using:
Information such as a boolean flag that allows to enable or disable the dispersion filter processing
Information such as a boolean flag that enables or disable the dispersion filter processing for early reflections sounds
Information such as a boolean flag that enables or disable the dispersion filter processing for diffracted sounds
Information such as a parameter to signal the duration of the dispersion filter e.g. in ms, typically between 0 and 100 ms or 1000 ms
Information such as a parameter to signal the dispersion filter gain
Information such as a parameter to signal the spatial spread of the dispersion filter, e.g., between 0 and ±180 degrees

The bitstream may optionally be stored on a digital storage medium such as a volatile or non-volatile memory.

Some aspects of the present invention may be formulated as:
1. Sound processing apparatus, comprising:
   a panner, e.g., related to FIG. 5 as a combination of Virtual Loudspeaker Processing and Binauralization; a panning of FIG. 6 and/or a Binauralization of FIG. 2 as a version of panning, for spatial positioning of a plurality of input signals and combining them into at least two spatial signals;
   a dispersion filter stage e.g., having one or more dispersion filters, for receiving the spatial signals and for dispersion filtering the spatial signals to obtain a set of filtered spatial signals;
   an interface e.g., L/R after the DFs in FIG. 2 or FIG. 5; or output of Panning in FIG. 6;

e.g., for further processing of the filtered signals for providing a number of output signals, based on the filtered spatial signals.
2. The sound processing apparatus of aspect 1, wherein the input signals comprise an early reflection signal and/or a diffracted sound signal.
   Section Association of Number of DFs with Number of Loudspeakers
3. The sound processing apparatus of aspect 1 or 2, wherein a number of dispersion filters contained in the dispersion filter stage corresponds to the number of output signals.

### Section DF-Filter

4. The sound processing apparatus of one of previous aspects, wherein the dispersion filter stage comprises at least one dispersion filter being an allpass filter.
5. The sound processing apparatus of one of previous aspects, wherein the dispersion filter stage comprises at least one dispersion filter being an Finite Impulse Response, FIR, filter or an Infinite Impulse Response, IIR, filter.
6. The sound processing apparatus of one of previous aspects, wherein at least one dispersion filter of the dispersion filter stage comprises a time-variant filter characteristic.
7. The sound processing apparatus of one of previous aspects, comprising a renderer for providing the plurality of input signals.
8. The sound processing apparatus of aspect 7, wherein the sound processing apparatus is configured for providing a direct sound component and a reverberated sound component.
9. The sound processing apparatus of aspect 8, wherein the dispersion filter stage is configured for filtering the set of spatial signals; wherein the sound processing apparatus is configured for excluding the direct sound component and the reverberated sound component from the dispersion filter stage.
10. The sound processing apparatus of one of previous aspects, comprising a dispersion filter generator configured for generating, e.g., during an initialization phase, at least one dispersion filter of the dispersion filter stage.
11. The sound processing apparatus of aspect 10, wherein the dispersion filter generator is configured for generating the at least one dispersion filter based on:
   a length determining an amount of temporal spread provided by the dispersion filter; e.g., related to decay time of a window
   a spatial spread, e.g., by a high-level control to change a degree of Inter-channel Cross Correlation; and/or
   a gain
12. The sound processing apparatus of aspect 10 or 11, wherein the dispersion filter generator is configured for generating the dispersion filter as a first dispersion filter for a first spatial signal; wherein the sound processing apparatus comprises a memory having stored thereon a set of stored noise signals of a same energy within a tolerance range and with different degrees of correlation with respect to each other;
   wherein the sound processing apparatus is configured for selecting form the stored noise signals as a basis for the noise sequences.
13. The sound processing apparatus of aspect 12, being configured for obtaining the noise signals based on at least one of:
   a characteristic that the noise signals are identical or weakly decorrelated sequences;
   a parameter, e.g., received as a bitstream parameter in a bitstream, indicating a length of the sequences
   a parameter, e.g., received as a bitstream parameter in a bitstream, indicating a decorrelation or a spatial spread strength
   a parameter, e.g. received as a bitstream parameter in a bitstream, related to Interaural Cross Correlation, IACC of a sound source with a small frontal aperture.
14. The sound processing apparatus of aspect 12 or 13, wherein the dispersion filter generator is configured for generating the first dispersion filter and the second dispersion filter with a frequency dependent filter decorrelation, e.g., obtained based on Interaural Cross Correlation, IACC.
15. The sound processing apparatus of one of aspects 12 to 14, wherein the first noise sequence and the second noise sequence comprise an equal energy level.
16. The sound processing apparatus of previous aspects, wherein a dispersion filter of the dispersion filter stage is based on a windowed noise sequence.
17. The sound processing apparatus of aspect 16, wherein the windowed noise sequence is based on or corresponds to a white noise sequence.
18. The sound processing apparatus of one of previous, wherein a dispersion filter of the dispersion filter stage is a first dispersion filter for a first spatial signal and a second dispersion filter is for filtering a different second spatial signal
   wherein the first dispersion filter and the second dispersion filter are based on an identical windowed noise sequence; or
   wherein the first dispersion filter and the second dispersion filter are based on different noise sequences that have a predefined correlation according to perceptual criteria.
19. The sound processing apparatus of one of previous aspects, being energy-preserving and being adjustable in view of a filter gain
20. The sound processing apparatus of one of previous aspects, being configured for applying dispersion filter processing with the dispersion filter stage only to the binauralized input signals
21. The sound processing apparatus of one of previous aspects, wherein the dispersion filter stage comprises at least a first dispersion filter for filtering a first spatial signal; and a second dispersion filter for filtering a second spatial signal; wherein the first dispersion filter and the second dispersion filter comprise a frequency dependent filter decorrelation, e.g., obtained based on Interaural Cross Correlation, IACC.

### Section Binauralization

22. The sound processing apparatus of one of previous aspects, wherein the panner comprises:
   a plurality of binauralization stages; wherein each binauralization stage is for receiving one of the input signals and for binauralizing the received input signal for obtaining a first binauralized channel and a second binauralized channel;
   a combiner for providing a first combination of the first binauralized channels of the binauralization stages; wherein a first spatial signal is based on the first combination; and for providing a second combination of the second binauralized channels of the binauralization stages; wherein a second spatial signal is based on the second combination.
23. The sound processing apparatus of one of aspects 1 to 21, wherein the panner comprises a virtual loudspeaker processor for receiving and processing the input signals to obtain intermediate spatial signals;
   a plurality of binauralization stages; wherein each binauralization stage is for receiving one of the intermediate spatial signals and for binauralizing the received intermediate spatial signal for obtaining a first binauralized channel and a second binauralized channel;
   a combiner for providing a first combination of the first binauralized channels of the binauralization stages; wherein a first spatial signal is based on the first combination; and for providing a second combination of the second binauralized channels of the binauralization stages; wherein a second spatial signal is based on the second combination.
24. The sound processing apparatus of aspect 22 or 23, wherein the binauralization stages are configured according to a head related transfer function, HRTF.
25. The sound processing apparatus of one of aspects 22 to 24, being configured for providing exactly two audio channels for the output signals.
26. The sound processing apparatus of one of aspects 1 to 21, wherein the panner is configured for
   receiving the input signals comprising at least one early reflection signal and/or at least one diffracted sound signal; and
   receiving a direct sound component and a reverberated sound component associated to the input signals; and
   wherein the spatial signals are each associated with a loudspeaker of a loudspeaker setup.
27. The sound processing apparatus of one of previous aspects, wherein output signals are associated each with an audio channel such as, for example, left/right, L/R; wherein the sound processing apparatus comprises a direct sound processor for processing a direct sound component associated with the plurality of input signals;
   wherein the panner further comprises a direct sound binauralization stage for receiving and binauralizing the direct sound component to obtain components each related to one of the audio channels;
   wherein the sound processing apparatus comprises a combiner for combining signals related to a same audio channel to obtain a first audio signal and a second audio signal.
28. The sound processing apparatus of one of previous aspects, output signals are associated each with an audio channel, e.g., L/R; wherein the sound processing apparatus comprises a reverberation processor for processing a late reverberation component associated with the plurality of input signals;
   wherein the panner further comprises a reverberation binauralization stage for receiving and binauralizing the late reverberation component to obtain components each related to one of the audio channels;
   wherein the sound processing apparatus comprises a combiner for combining signals related to a same audio channel to obtain a first audio signal and a second audio signal.
29. The sound processing apparatus of one of previous aspects, configured for filtering all input signals by use of exactly two dispersion filters of the dispersion filter stage.
30. The sound processing apparatus of aspect 29, wherein the number of exactly two dispersion filters is independent from a number of input signals and/or independent from a number of sound sources providing the plurality of input signals.
31. The sound processing apparatus of one of previous aspects, wherein the sound processing apparatus is configured for receiving the input signals or a basis thereof as a part of a bitstream and for using and/or configuring the dispersion filter stage based on one or more data fields of the bitstream, the one or more data fields comprising an indication of a use and/or configuration of the dispersion filter.
32. A decoder for decoding a bitstream comprising information representing an audio signal; the decoder comprising:
   a sound processing apparatus of one of previous aspects.
33. An encoder for encoding an audio signal into a bitstream, the encoder configured for generating the bitstream so as to comprise one or more of:
   information, e.g., a boolean flag, that allows to enable or disable a dispersion filter processing;
   information, e.g., a boolean flag, that enables or disables the dispersion filter processing for early reflections sounds;
   information, e.g., a boolean flag, that enables or disable the dispersion filter processing for diffracted sounds
   information indicating a parameter to signal the duration of the dispersion filter used for the dispersion filter processing e.g. in ms, as example between 0 ms and 100 ms or between 0 ms and 1000 ms
   information indicating a parameter to signal the dispersion filter gain
   information indicating a parameter to signal the spatial spread of the dispersion filter, e.g., between 0 degree and ±180 degrees
34. A bitstream comprising:
   information indicating at least one spatial positioned input signal of an audio scene; and
   one or more data fields comprising information that comprises an indication of a use and/or configuration of the dispersion filter for generating audio signals from the bitstream.
35. The bitstream of aspect 34, wherein the information in the one or more data fields indicates at least one of:
   information, e.g., a boolean flag, that allows to enable or disable a dispersion filter processing;
   information, e.g., a boolean flag, that enables or disables the dispersion filter processing for early reflections sounds;
   information, e.g., a boolean flag, that enables or disable the dispersion filter processing for diffracted sounds
   information indicating a parameter to signal the duration of the dispersion filter used for the dispersion filter processing e.g. in ms, as example between 0 ms and 100 ms or between 0 ms and 1000 ms
   information indicating a parameter to signal the dispersion filter gain
   information indicating a parameter to signal the spatial spread of the dispersion filter, e.g., between 0 degree and ±180 degrees
36. Method for sound processing, the method comprising:
   spatial positioning of a plurality of input signals and combining them into at least two spatial signals;
   dispersion filtering the spatial signals to obtain a set of filtered spatial signals;
   providing a number of output signals, based on the filtered spatial signals.
37. Method for encoding an audio scene, the method comprising:
   generating, from the audio scene, information indicating at least one spatial positioned input signal of the audio scene; and
   one or more data fields comprising information that comprises an indication of a use and/or configuration of the dispersion filter for generating audio signals from the encoded audio scene.
38. A computer program for implementing the method of aspect 36 or 37 when being executed on a computer or signal processor.

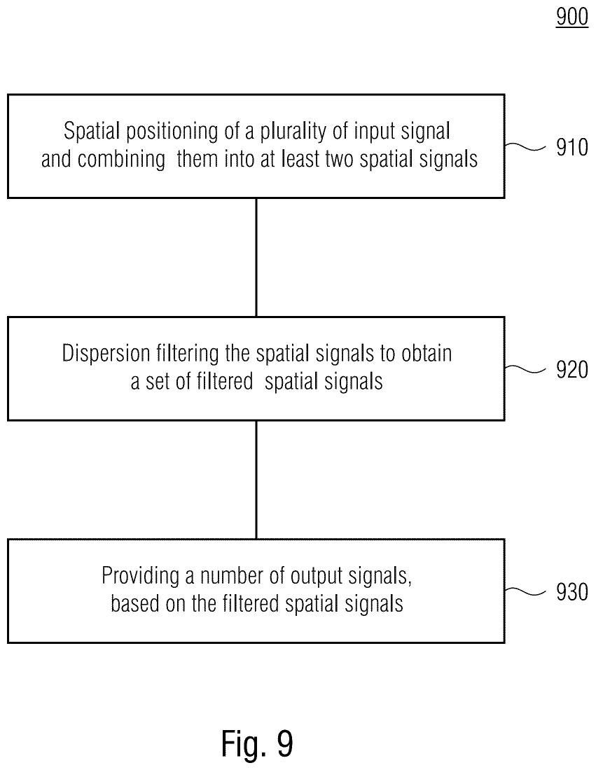

FIG. 9 shows a schematic flowchart of a method 900 according to an embodiment. A step 910 comprises spatial positioning of a plurality of input signals and combining them into at least two spatial signals. A step 920 comprise dispersion filtering the spatial signals to obtain a set of filtered spatial signals. A step 930 comprises providing a number of output signals based on the filtered spatial signals. Method 900 may be used, for example, for sound processing, e.g., using one of the sound processing apparatuses described herein.

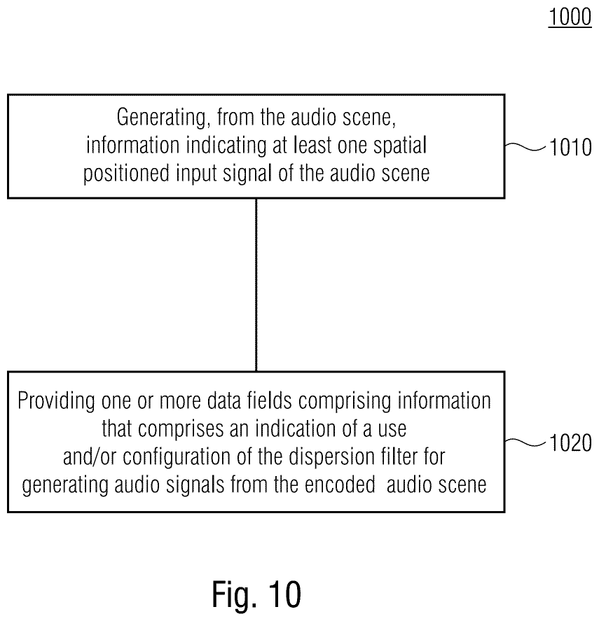

FIG. 10 shows a schematic flowchart of a method 1000 according to an embodiment that may be used, for example, for encoding an audio scene, e.g., using encoder 70. A step 1010 comprises generating, from the audio scene, information indicating at least one spatial position input signal of the audio scene. A step 1020 comprises providing one or more data fields comprising information that comprises an indication of a use and/or configuration of the dispersion filter for generating audio signals from the encoded audio scene.

At least some of the embodiments related to the present invention aim to efficiently improve the perceived plausibility and pleasantness of early reflections in acoustic room simulations and/or rendering. The concept is implemented, tested and described in detail in connection with a binaural reproduction scenario, but can be extended to other forms of audio reproduction.

Embodiments described herein may be amended, amongst others, in real-time auditory virtual environments and/or in real-time virtual and augmented reality applications.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus.

The inventive encoded audio signal can be stored on a digital storage medium or can be transmitted on a transmission medium such as a wireless transmission medium or a wired transmission medium such as the Internet.

Depending on certain implementation requirements, embodiments of the invention can be implemented in hardware or in software. The implementation can be performed using a digital storage medium, for example a floppy disk, a DVD, a CD, a ROM, a PROM, an EPROM, an EEPROM or a FLASH memory, having electronically readable control signals stored thereon, which cooperate (or are capable of cooperating) with a programmable computer system such that the respective method is performed.

Some embodiments according to the invention comprise a data carrier having a bitstream and/or having electronically readable control signals which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

### LITERATURE

[1] Allen, J. B. and D. A. Berkley, Image method for efficiently simulating small-room acoustics. J. Acoust. Soc. Am., 1979. 65 (4): p. 943-950.
[2] Stephenson, U., Comparison of the mirror image source method and the sound particle simulation method. Applied Acoustics, 1990. 29 (1): p. 35 . . . 72 DOI: https://doi.org/10.1016/0003-682X(90) 90070-B.
[3] Kulowski, A., Algorithmic Representation of the Ray Tracing Technique. Applied Acoustics, 1985. 18: p. 449-469.
[4] Funkouser, T., A Beam Tracing Approach to Acoustic Modeling for Interactive Virtual Environments. 1998.
[5] Gerzon, M. A. The Design of Distance Panpots. 92nd AES Convention. 1992. Vienna, Austria.
[6] Moorer, J. A., About This Reverberation Business. Computer Music Journal, 1979. 3 (2): p. 13-28. Available from: https://www.music.mcgill.ca/˜gary/courses/papers/Moorer-Reverb-CMJ-1979.pdf.
[7] Borß, C., An Improved Parametric Model for the Design of Virtual Acoustics and its Applications. Fakultät für Elektrotechnik. doctoral dissertation. 2011: Ruhr-Universität Bochum

1. Sound processing apparatus, comprising:
a panner for spatial positioning of a plurality of input signals and combining the input signals into at least two spatial signals;
a dispersion filter stage for receiving the spatial signals and for dispersion filtering the spatial signals to acquire a set of filtered spatial signals;
an interface for providing a number of output signals, based on the filtered spatial signals.

2. The sound processing apparatus of claim 1, wherein the input signals comprise an early reflection signal and/or a diffracted sound signal of an audio scene.

3. The sound processing apparatus of claim 1, wherein a number of dispersion filters comprised in the dispersion filter stage corresponds to the number of output signals.

4. The sound processing apparatus of claim 1, wherein the dispersion filter stage comprises at least one dispersion filter being an allpass filter.

5. The sound processing apparatus of claim 1, wherein the dispersion filter stage comprises at least one dispersion filter being an Finite Impulse Response, FIR, filter or an Infinite Impulse Response, IIR, filter.

6. The sound processing apparatus of claim 1, wherein at least one dispersion filter of the dispersion filter stage comprises a time-variant filter characteristic.

7. The sound processing apparatus of claim 1, comprising a renderer for providing the plurality of input signals.

8. The sound processing apparatus of claim 7, wherein the sound processing apparatus is configured for providing a direct sound component and a reverberated sound component.

9. The sound processing apparatus of claim 8, wherein the dispersion filter stage is configured for filtering the set of spatial signals; wherein the sound processing apparatus is configured for excluding the direct sound component and the reverberated sound component from the dispersion filter stage.

10. The sound processing apparatus of claim 1, comprising a dispersion filter generator configured for generating, e.g., during an initialization phase, at least one dispersion filter of the dispersion filter stage.

11. The sound processing apparatus of claim 10, wherein the dispersion filter generator is configured for generating the at least one dispersion filter based on:
a length determining an amount of temporal spread provided by the dispersion filter;
a spatial spread, e.g., by a high-level control to change a degree of Inter-channel Cross Correlation; and/or
a gain.

12. The sound processing apparatus of claim 10, wherein the dispersion filter generator is configured for generating the dispersion filter as a first dispersion filter for a first spatial signal; wherein the sound processing apparatus comprises a memory having stored thereon a set of stored noise signals of a same energy within a tolerance range and with different degrees of correlation with respect to each other;
wherein the sound processing apparatus is configured for selecting from the stored noise signals as a basis for the noise sequences.

13. The sound processing apparatus of claim 12, being configured for acquiring the noise signals based on at least one of:
a characteristic that the noise signals are identical or weakly decorrelated sequences;
a parameter, e.g., received as a bitstream parameter in a bitstream, indicating a length of the sequences;
a parameter, e.g., received as a bitstream parameter in a bitstream, indicating a decorrelation or a spatial spread strength; and
a parameter, e.g. received as a bitstream parameter in a bitstream, related to Interaural Cross Correlation, IACC, of a sound source with a small frontal aperture.

14. The sound processing apparatus of claim 12, wherein the dispersion filter generator is configured for generating the first dispersion filter and a second dispersion filter with a frequency dependent filter decorrelation, e.g., acquired based on Interaural Cross Correlation, IACC.

15. The sound processing apparatus of claim 12, wherein the first noise sequence and the second noise sequence comprise an equal energy level.

16. The sound processing apparatus of claim 1, wherein a dispersion filter of the dispersion filter stage is based on a windowed noise sequence.

17. The sound processing apparatus of claim 16, wherein the windowed noise sequence is based on or corresponds to a white noise sequence.

18. The sound processing apparatus of claim 1, wherein a dispersion filter of the dispersion filter stage is a first dispersion filter for a first spatial signal and a second dispersion filter is for filtering a different second spatial signal;
wherein a first dispersion filter and a second dispersion filter are based on an identical windowed noise sequence; or
wherein the first dispersion filter and the second dispersion filter are based on different noise sequences that comprise a predefined correlation according to perceptual criteria.

19. The sound processing apparatus of claim 1, being energy-preserving and being adjustable in view of a filter gain.

20. The sound processing apparatus of claim 1, being configured for applying dispersion filter processing with the dispersion filter stage only to binauralized input signals.

21. The sound processing apparatus of claim 1, wherein the dispersion filter stage comprises at least a first dispersion filter for filtering a first spatial signal; and a second dispersion filter for filtering a second spatial signal; wherein the first dispersion filter and the second dispersion filter comprise a frequency dependent filter decorrelation, e.g., acquired based on Interaural Cross Correlation, IACC.

22. The sound processing apparatus of claim 1, wherein the panner comprises:
a plurality of binauralization stages; wherein each binauralization stage is for receiving one of the input signals and for binauralizing the received input signal for acquiring a first binauralized channel and a second binauralized channel;
a combiner for providing a first combination of the first binauralized channels of the binauralization stages; wherein a first spatial signal is based on the first combination; and for providing a second combination of the second binauralized channels of the binauralization stages; wherein a second spatial signal is based on the second combination.

23. The sound processing apparatus of claim 1, wherein the panner comprises a virtual loudspeaker processor for receiving and processing the input signals to acquire intermediate spatial signals;
a plurality of binauralization stages; wherein each binauralization stage is for receiving one of the intermediate spatial signals and for binauralizing the received intermediate spatial signal for acquiring a first binauralized channel and a second binauralized channel;
a combiner for providing a first combination of the first binauralized channels of the binauralization stages; wherein a first spatial signal is based on the first combination; and for providing a second combination of the second binauralized channels of the binauralization stages; wherein a second spatial signal is based on the second combination.

24. The sound processing apparatus of claim 22, wherein the binauralization stages are configured according to a head related transfer function, HRTF.

25. The sound processing apparatus of claim 22, being configured for providing exactly two audio channels for the output signals.

26. The sound processing apparatus of claim 1, wherein the panner is configured for
receiving the input signals comprising at least one early reflection signal and/or at least one diffracted sound signal; and
receiving a direct sound component and a reverberated sound component associated to the input signals; and
wherein the spatial signals are each associated with a loudspeaker of a loudspeaker setup.

27. The sound processing apparatus of claim 1, wherein the output signals are associated each with an audio channel, e.g., L/R; wherein the sound processing apparatus comprises a direct sound processor for processing a direct sound component associated with the plurality of input signals;
wherein the panner further comprises a direct sound binauralization stage for receiving and binauralizing the direct sound component to acquire components each related to one of the audio channels;
wherein the sound processing apparatus comprises a combiner for combining signals related to a same audio channel to acquire a first audio signal and a second audio signal.

28. The sound processing apparatus of claim 1, wherein the output signals are associated each with an audio channel, e.g., L/R; wherein the sound processing apparatus comprises a reverberation processor for processing a late reverberation component associated with the plurality of input signals;
wherein the panner further comprises a reverberation binauralization stage for receiving and binauralizing the late reverberation component to acquire components each related to one of the audio channels;
wherein the sound processing apparatus comprises a combiner for combining signals related to a same audio channel to acquire a first audio signal and a second audio signal.

29. The sound processing apparatus of claim 1, configured for filtering all input signals by use of exactly two dispersion filters of the dispersion filter stage for filtering the spatial signals acquired from all input signals.

30. The sound processing apparatus of claim 29, wherein the number of exactly two dispersion filters is independent from a number of input signals and/or independent from a number of sound sources providing the plurality of input signals.

31. The sound processing apparatus of claim 1, wherein the sound processing apparatus is configured for receiving the input signals or a basis thereof as a part of a bitstream and for using and/or configuring the dispersion filter stage based on one or more data fields of the bitstream, the one or more data fields comprising an indication of a use and/or configuration of the dispersion filter stage.

32. A decoder for decoding a bitstream comprising information representing an audio signal; the decoder comprising:
a sound processing apparatus of claim 1.

33. An encoder for encoding an audio signal into a bitstream, the encoder configured for generating the bitstream so as to comprise one or more of:
information, e.g., a boolean flag, that allows to enable or disable a dispersion filter processing;
information, e.g., a boolean flag, that enables or disables the dispersion filter processing for early reflections sounds;
information, e.g., a boolean flag, that enables or disable the dispersion filter processing for diffracted sounds
information indicating a parameter to signal the duration of the dispersion filter used for the dispersion filter processing e.g. in ms, as example between 0 ms and 100 ms
information indicating a parameter to signal the dispersion filter gain
information indicating a parameter to signal the spatial spread of the dispersion filter, e.g., between 0 degree and ±180 degrees

34. A bitstream comprising:
information indicating at least one spatial positioned input signal of an audio scene; and
one or more data fields comprising information that comprises an indication of a use and/or configuration of a dispersion filter for generating audio signals from the bitstream.

35. The bitstream of claim 34, wherein the information in the one or more data fields indicates at least one of:
information, e.g., a boolean flag, that allows to enable or disable a dispersion filter processing;
information, e.g., a boolean flag, that enables or disables the dispersion filter processing for early reflections sounds;
information, e.g., a boolean flag, that enables or disable the dispersion filter processing for diffracted sounds
information indicating a parameter to signal the duration of the dispersion filter used for the dispersion filter processing e.g. in ms, as example between 0 ms and 100 ms
information indicating a parameter to signal the dispersion filter gain
information indicating a parameter to signal the spatial spread of the dispersion filter, e.g., between 0 degree and ±180 degrees.
